(19) United States
(12) Patent Application Publication
(10) Pub. No.: US 2014/0367501 A1
(43) Pub. Date: Dec. 18, 2014

(54) SYSTEMS AND METHODS TO REMOVE HYDROCARBON OILS FROM CONTAMINATED DRILL CUTTINGS

(71) Applicant: BAKER HUGHES INCORPORATED, Houston, TX (US)

(72) Inventors: Anuradee Witthayapanyanon, The Woodlands, TX (US); Lirio Quintero, Houston, TX (US); Paige M. Kiesewetter, Katy, TX (US); Kenneth R. Carlsson, Houston, TX (US)

(73) Assignee: BAKER HUGHES INCORPORATED, Houston, TX (US)

(21) Appl. No.: 14/303,407

(22) Filed: Jun. 12, 2014

Related U.S. Application Data
(60) Provisional application No. 61/834,683, filed on Jun. 13, 2013.

(51) Int. Cl. E21B 21/06; B02C 23/14; B02C 23/40; B02C 23/30; B02C 23/38

(52) U.S. Cl. CPC E21B 21/066; B02C 23/30; B02C 23/38; B02C 23/40; B02C 23/14
USPC 241/42; 241/41

(57) ABSTRACT

A system for treating drill cuttings may include a first stage that receives the drill cuttings and generates a first drill cuttings slurry and a second stage that receives the first drill cuttings slurry and generates solids. The first stage may include a mixer receiving at least one additive from at least one treatment fluid supply. The mixer mixes the at least one additive with the drill cuttings to form a drill cuttings mixture and reduces the drill cuttings to a predetermined size. The first stage also includes a separator receiving the drill cutting mixture. The separator separates liquids from solids in the drill cuttings mixture to form the first drill cuttings slurry. The second stage may include a mixer that mixes a cleaning fluid from a second treatment fluid supply with the drill cuttings to form a second drill cuttings mixture. The second stage may also include a separator receiving the second drill cutting mixture. The separator separates liquids from solids in the drill cuttings mixture to form the solids stream and the liquids stream.

### CROSS-REFERENCE TO RELATED APPLICATIONS

This application claims priority from U.S. Provisional Patent Application Ser. No.: 61/834683, filed Jun. 13, 2013, the disclosure of which is the entire disclosure of which is incorporated herein by reference in its entirety.

### FIELD OF THE DISCLOSURE

This disclosure is directed to systems for decontaminating drill cuttings.

### BACKGROUND OF THE DISCLOSURE

Non aqueous drilling fluids (NAF), including oil-based drilling fluids, synthetic drilling fluids, form a general class of materials that may minimally comprise oil soluble additives, e.g., emulsifiers, and a mixture of particulate solids in a hydrocarbon fluid. These fluids are circulated through and around the drill bit to lubricate and cool the bit, provide suspension to help support the weight of the drill pipe and casing, cover the wellbore surface with a filter cake to prevent caving in and weight to balance against undesirable fluid flow from the formation, and to carry drill cuttings to the surface. At the surface, the drill cuttings are separated from the used drilling fluid. For effective waste management, the cuttings should be cleaned of contaminants, such as the oil-based drilling mud.

The present disclosure addresses the first treatment of drill cuttings, as well as other naturally occurring substances.

SUMMARY OF THE DISCLOSURE

In aspects, the present disclosure provides a system for treating drill cuttings. The system may include a first stage that receives the drill cuttings and generates a first drill cuttings slurry and a second stage that receives the first drill cuttings slurry and generates solids. The first stage may include at least one treatment fluid supply, a mixer receiving at least one additive from the at least one treatment fluid supply and mixing the at least one additive with the drill cuttings to form a drill cuttings mixture and to reducing the drill cuttings to a predetermined size, and a separator receiving the drill cutting mixture, the separator configured to separate liquids from solids in the drill cuttings mixture to form the first drill cuttings slurry. The second stage may include a second treatment fluid supply; a mixer configured to mix a cleaning fluid from the second treatment fluid supply with the drill cuttings to form a second drill cuttings mixture; and a separator receiving the second drill cutting mixture, the separator configured to separate liquids from solids in the drill cuttings mixture to form the solids stream and the liquids stream.

Examples of certain features of the disclosure have been summarized (albeit rather broadly) in order that the detailed description thereof that follows may be better understood and in order that the contributions they represent to the art may be appreciated. There are, of course, additional features of the disclosure that will be described hereinafter and which will form the subject of the claims appended hereto.

### BRIEF DESCRIPTION OF THE FIGURES

For detailed understanding of the present disclosure, reference should be made to the following detailed description of the preferred embodiment, taken in conjunction with the accompanying drawing:

FIG. 1 illustrates an offshore rig that may use drill cutting processing systems of the present disclosure; and

FIG. 2 schematically illustrates a drill cuttings processing system in accordance with one embodiment of the present disclosure.

### DETAILED DESCRIPTION OF THE DISCLOSURE

Embodiments of the present disclosure may be used to decontaminate drill cuttings using one or more treatment steps that involve chemical-mechanical actions. At each step, the drill cuttings are treated with a treatment fluid. As used herein, the term “treat” refers to a process wherein two or more materials are contacted to cause one or more desired interactions. For example, the interaction may be a chemical interaction between a chemical and a hydrocarbon oil on a drill cutting solid. Another example may include a mechanical interaction between a water-based solution and the hydrocarbon oil on a drill cutting solid. Illustrative, but not exhaustive, types of treatment including cleaning, cleaning, rinsing, etc. A treatment fluid may be any fluid selected to have a specified interaction with one or more selected materials.

The treatment systems and methods of the present disclosure may be used in any number of situations as industrial applications wherein one or more materials require decontamination. An illustrative use of the present treatment systems and methods is to process drill cuttings generated while drilling a wellbore. The wellbore may be used for recovering hydrocarbons, to access geothermal energy, to access minerals, to produce water, etc. Further, the present treatment systems and methods may be used on land or offshore. Merely for brevity, the present disclosure will be discussed in connection with offshore wellbore drilling operations.

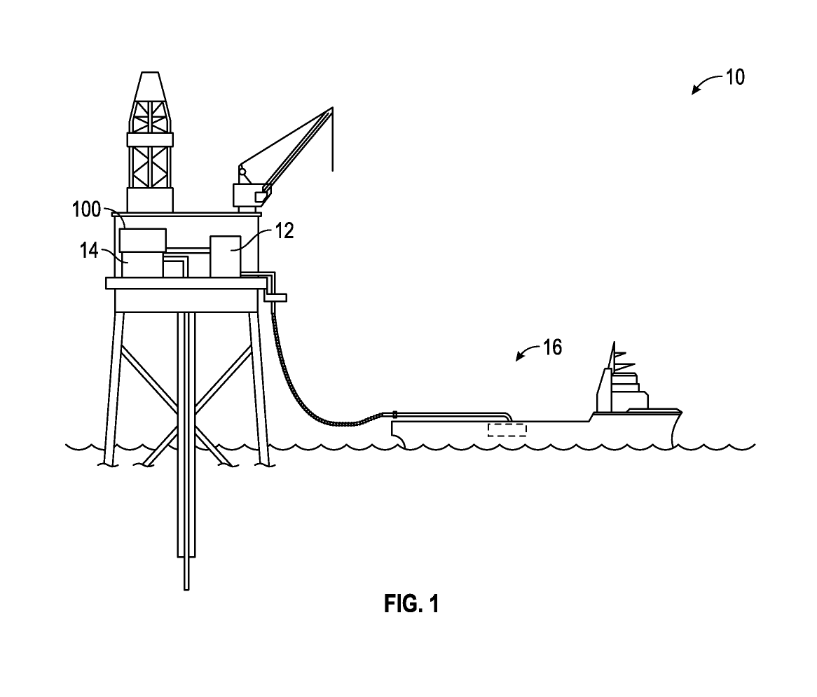

Referring now to FIG. 1, there is shown an offshore drilling rig 10 for drilling subsea wellbores. As noted previously, a prevalent engineered fluid that is frequently used in subsea drilling operations conducted from the rig 10 is drilling fluid or “drilling mud.” As used herein, the term drilling fluid is a water-based or oil-based liquid that includes entrained solids. The oil-based liquid may be diesel or synthetic oil. The drilling fluid may also use mineral oil or paraffin. Typically, the drilling fluid is circulated in a fluid circulation system that includes one or more pump units and a drilling fluid supply 12 and a cuttings recovery system 14. The cuttings recovery system 14 may include equipment such as shale shakers, conveyors, pumps, and other devices. The drilling fluid may be transported to and from the rig 10 with a transport vessel 16 such as a barge or boat.

As will be discussed in greater detail below, the rig 10 may include a system 100 that may be used to process recovered drill cuttings received from the cuttings recovery system 14 to remove oil from the drill cuttings to thereby facilitate the disposal of the drill cuttings. In embodiments, the system 100 may use non-thermal, chemical-mechanical actions to remove hydrocarbon oils from contaminated drill cuttings. In a first treatment stage, a mechanical device reduces the size of the drill cutting solids while mixing the cuttings with the first treatment solution. The reduction of average drill cutting particle size during mixing promotes formation of additional contact surface area and enhanced kinetic interaction between the oily contaminant and the first treatment solution. In one arrangement, a desirable range of particle sizes in the first treatment cycle may be between 200 to 1,000 micrometers. After the mixing/size reduction stage, the drill cuttings undergo additional treatments. Optionally, further reduction of particle size of the drill cuttings may occur. Optionally, a device may be used to inject gas bubbles into the rinse slurry to generate turbulent mixing conditions for removing residual additives from the cuttings. Further aspects are discussed in greater detail below.

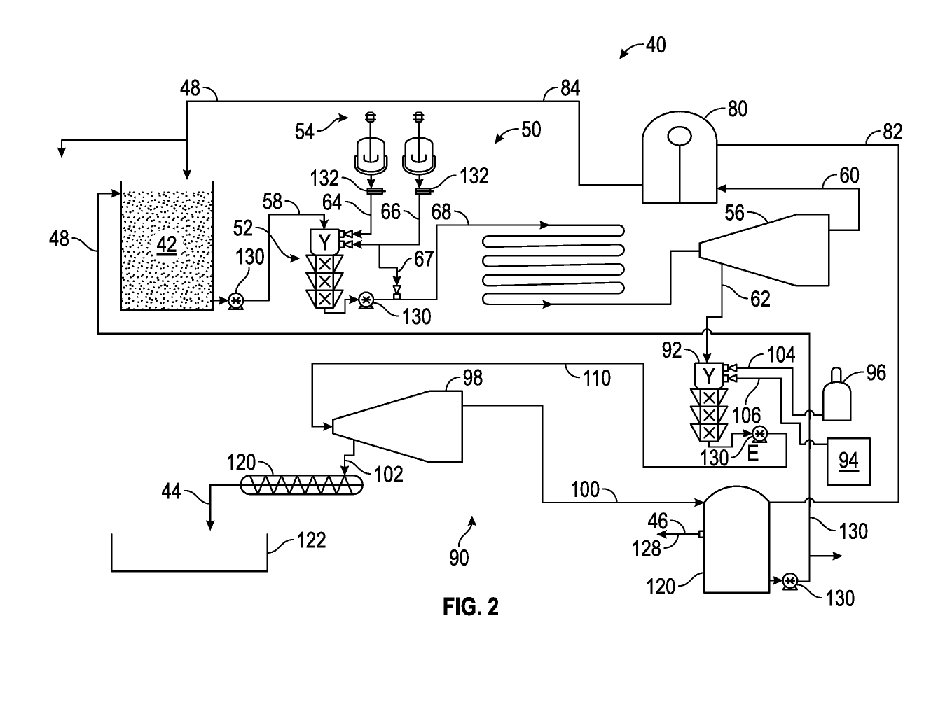

Referring now to FIG. 2, there is shown a system 40 for processing contaminated drill cuttings 42 according to one embodiment of the present disclosure. In one non-limiting arrangement, the system 40 includes a first treatment stage 50 and a second treatment stage 90. While FIG. 2 shows only one of each stage, it should be understood that the first treatment and/or second treatment of the drill cuttings may be performed using two or more stages. Generally, the system 40 processes the drill cuttings 42 to generate a solids discharge 44, an oil discharge 46, and a water-additive mixture discharges 48. The stages 40, 90 utilize chemical and mechanical interaction with the drill cuttings to remove contaminants. Thermal energy is not added as a primary or secondary mechanism as part of the decontamination of the drill cuttings. Thus, while some thermal energy may be incident with the operation to system 40, such thermal energy is not functionally effective to clean or wash the drill cuttings. The system 40 may be operated in a continuous fashion or in a batch process fashion.

The first treatment stage 50 treats the drill cutting using a mixer 52, one or more additive supplies 54, and a separator 56. The first treatment stage 50 processes the drill cuttings and discharges a liquid stream via line 60 and a solids stream via line 62. The mixer 52 receives the drill cuttings via a line 58 and receives one or more additives from the additive supplies 54 via lines 64, 66. The additive(s) may be applied before, during, and/or after the drill cuttings are processed in the mixer 52. For example, additives may be applied via the lines 64, 66 prior or during processing to the mixer 52. Also, additives may also be applied after processing to the drill cuttings via the line 67.

The mixer 52 mixes the additive(s) and the drill cuttings to form a drill cuttings slurry. The mixer 52 may be configured to perform two discrete functions: mix the additive(s) with the drill cuttings and reduce the size of the drill cuttings. For example, the mixer 52 may include one or more agitator elements that are shaped and sized to blend or homogenize the additive(s) and drill cuttings and one more size reducing elements that cut, crush, shear, or otherwise disintegrate the drill cuttings. These elements may be in the form of blades, vanes, rollers, cones, or other known devices for reducing particle size. The particle size reduction may be done in a single stage or through multiple stages. As noted previously, a desirable range of particle sizes in the first treatment cycle may be between 200 to 1,000 micrometers. The upper end of the range may be influenced by the minimal amount of desirable contact area to be available for chemical interaction between the drill cuttings and the additive(s). The lower end of the particle size may be influenced by the capacity and operating nature of the separator 56. That is, reducing the particles size too small may impair the ability of the separator 56 to separate the fluids from solids. The mixing and particle size reduction can occur sequentially or concurrently. While some particle size reduction may be incident with a mixing process, the term “particle size reduction” as used in the disclosure refers to an in intentional process wherein the particle size is reduced to at least a predetermined size or to within a predetermine range of size. Relative to particle size, it certain applications, a measure of particle size is shown as a distribution. For example, a particle size of 60 micrometers (d50) means 50% of solid particles has a particle size greater or equal to 60 micrometers.

A line 68 transfers the drill cuttings slurry from the mixer 52 to the separator 56. In some embodiments, it may be desirable to have the additive(s) interact with the drill cuttings for a specified amount of time. It may also be desirable to maintain flow of the drill cuttings slurry to accommodate a continuous processing of drill cuttings. Therefore, the line 68 may have a length selected to provide a predetermined or controllable amount of time for interaction between the additive(s) and the drill cuttings before the cuttings enter the separator 56.

In one non-limiting arrangement, the separator 56 may be a centrifugal-type separator that spins the drill cuttings slurry to separate solids from liquids. Other illustrative, but not exhaustive separators, include cyclone separators, centrifuges, separation disc type decanter centrifuges, vane decanters, decanters, dehydrators, etc. The separators 56 may generates a separated liquids stream that is discharged via the line 60 and a separated solids stream that is discharged via the line 62.

The separated liquids may be conveyed to a liquid-liquid separator 80. In one arrangement, the separator 80 separates the separated liquid into an oil stream and a liquid-additive mixture stream. The liquid may be water or another liquid substance. The oil stream is conveyed via a line 82 to a second liquid-liquid separator 120. The water-additive mixture is conveyed via a line 84 to a disposal site and/or applied to the drill cuttings 42 entering the first treatment stage 50. Thus, the additive(s) recovered from the first treatment stage 50 may be reused. Optionally, a separator (not shown) positioned along line 84 may be used to separate the water and the additive(s).

The second treatment stage 90 removes residual oil and additive(s) from the solids received from the separator 56 and discharges a liquid stream via a line 100 and a solids stream via line 102. The second treatment stage 90 treats the solids stream using a mixer 92, a cleaning fluid supply 94, a gas supply 96, and a separator 98. The mixer 92 mixes together the gas received form the gas supply 96 via line 104, the cleaning liquid received from the cleaning fluid supply 94 via line 106, and the solids stream received via line 62. In one embodiment, the mixer 92 may be configured to perform two discrete functions: mix the gas, cleaning liquid, and the drill cuttings and reduce the size of the drill cuttings. The particle size reduction may be performed in a manner previously described. In other embodiments, the mixer 92 may be configured to only mix the gas and cleaning liquid with the drill cuttings.

The cleaning fluid provided by the cleaning fluid supply 94 may be any form of water or water based liquid (e.g., brine, process water, seawater, etc.). For brevity, the term “water” as used herein refers to water in all forms: water mixtures, water solutions, etc. Additionally, one or more selected additives may be added to the cleaning fluid. In some embodiments, the cleaning fluid may be gasified with oxygen, nitrogen, or other gas. The cleaning fluid interacts with the drill cuttings to separate residual oil and additive(s) from the solid drill cuttings. The gas provided by the gas supply 96 may be air, oxygen, nitrogen, or any other suitable gas. The gas may be introduced into the mixer to increase turbulence and thereby enhance the removal of residual oil and additives from the drill cuttings. The mixer 92 processes the drill cuttings using the gas and the cleaning liquid to generate a second drill cuttings slurry.

The separator 98 receives the second drill cuttings slurry from the mixer 92 via lines 110. The separator 98 may any of the types of separators previously described. The separator 96 processes the second drill cuttings slurry and discharges separated solids via a line 102 and the separated liquids via a line 100.

The separated solids discharged from the line 102 may be conveyed via a suitable conveyor such as an auger 120 to a container 122 for disposal.

The separated liquids discharged from line 100 may be conveyed to the liquid-liquid separator 120. The liquid-liquid separator 120 separates the separated liquid into an oil stream and a water-additive mixture stream. The oil stream is conveyed via a line 128 to a discharge. The water-additive mixture is conveyed via a line 130 to a disposal site and/or applied to the drill cuttings 42 entering the first treatment stage 50. Thus, the additive(s) recovered after the second treatment stage may also be reused. Optionally, a separator (not shown) positioned along line 130 may be used to separate the water and the additive(s).

It should be understood that various devices and system may be used in conjunction with the system 40. For example, fluid movers such as pumps 130 may be used to pump the drill cuttings along the various lines used in the system 40. The pumps may be positive displacement pumps, centrifugal pumps, etc. Additional metering pumps 132 may be used to inject the desired amount of additive(s) into the first and second stages 50, 90.

Additionally, it should be understood that additional treatment stages may be used before and/or after the first and second stages 50, 90. For example, pretreatment or post-treatment stages may include mechanical processes such as drying or filtering or treating the drill cuttings with one or more additives.

The additives used to treat the drill cuttings include any chemicals such as surfactants, be stabilizing agent(s), and water softeners.

Suitable stabilizing agent(s) include, but are not limited to, an alcohol, solvent, mutual solvent, glycols, polyglycols and polyglycerols,. The stabilizing agent(s) may be selected to interact with the contaminated oil and/or cuttings to enhance the effectiveness of surfactant and/or surfactant mixtures. The stabilizing agent(s) may be selected to reduce the overall viscosity of the contaminant oil on cuttings. Also the stabilizing agent(s) may be selected to decrease the hydrophobicity of the contaminant to be removed. In other situations, the stabilizing agent(s) may be selected to inhibit or prevent water used during the surfactant treatment from unfavorably reacting with the materials in the drill cuttings.

Suitable classes of water softeners/builders include, but are not limited to, coordination compounds, phosphates (complex phosphates, polyphosphates), silicates, zeolites, carbonates, and citrates. Illustrative coordination compounds include, but are not limited to, Ethylenediaminetetraacetic acid (EDTA); Illustrative Phosphates include, but are not limited to, trisodium phosphate, disodium phosphate, tetrasodium pyrophosphate, sodium tripolyphosphate, sodium tetraphosphate, Sodium hexametaphosphate; Illustrative silicates include, but are not limited to, sodium silicate; Illustrative carbonates include, but are not limited to, sodium carbonate, potassium carbonate, sodium percarbonate; Illustrative citrates include, but are not limited to, sodium citrate, calcium citrate, citric acid.

Suitable anionic surfactants selected from the group consisting of alkali metal alkyl sulfates, alkyl ether sulfonates, alkyl sulfonates, alkyl aryl sulfonates, linear and branched alkyl ether sulfates and sulfonates, alcohol polypropoxylated sulfates, alcohol polyethoxylated sulfates, alcohol polypropoxylated polyethoxylated sulfates, alkyl disulfonates, alkylaryl disulfonates, alkyl disulfates, alkyl sulfosuccinates, alkyl ether sulfates, linear and branched ether sulfates, alkali metal carboxylates, fatty acid carboxylates, and phosphate esters; suitable cationic surfactants include, but are not necessarily limited to, arginine methyl esters, alkanolamines and alkylenediamides. Suitable surfactants may also include surfactants containing a non-ionic spacer-arm central extension and an ionic or nonionic polar group. Other suitable surfactants are dimeric or gemini surfactants and cleavable surfactants. In certain applications, NaOH may be used to improve the efficiency of the additives. Baker Hughes Incorporated surfactant DFE-1621, for the surfactant. Suitable surfactants include, but are not limited to, anionic, nonionic, cationic, amphoteric, extended surfactants and blends thereof Still other suitable nonionic surfactants include, but are not necessarily limited to, alkyl polyglycosides, sorbitan esters, methyl glucoside esters, amine ethoxylates, diamine ethoxylates, polyglycerol esters, alkyl ethoxylates, alcohols that have been polypropoxylated and/or polyethoxylated or both. pH control agent may be used to improve the efficiency of the treatment fluids. Suitable pH control agents include, but not limited to, sodium hydroxide.

The term “fluid” or “fluids” includes liquids, gases, hydrocarbons, multi-phase fluids, mixtures of two of more fluids, water, brine, engineered fluids such as drilling mud, fluids injected from the surface such as water, and naturally occurring fluids such as oil and gas. Additionally, references to water should be construed to also include water-based fluids; e.g., brine or salt water.

The terms “solids” and “cuttings” have been used interchangeably to refer to the solid and semi-solid materials recovered from a wellbore while drilling. The term “liquids” refers to pure liquids as well as liquid mixtures. The term “water” refers to any water, whether processed or unprocessed.

While the foregoing disclosure is directed to the preferred embodiments of the disclosure, various modifications will be apparent to those skilled in the art. It is intended that all variations within the scope of the appended claims be embraced by the foregoing disclosure.

What is claimed is:

1. A system for treating drill cuttings, comprising:
a first stage receiving the drill cuttings and generating a first drill cuttings slurry, the first stage including:
at least one treatment fluid supply,
a mixer receiving at least one additive from the at least one treatment fluid supply, the mixer configured to mix the at least one additive with the drill cuttings to form a drill cuttings mixture and to reduce the drill cuttings to a predetermined size, and
a separator receiving the drill cutting mixture, the separator configured to separate liquids from solids in the drill cuttings mixture to form the first drill cuttings slurry; and
a second stage receiving the first drill cuttings slurry and generating a solids stream and a liquids stream, the second stage including:
a second treatment fluid supply;
a mixer configured to mix a cleaning fluid from the second treatment fluid supply with the drill cuttings to form a second drill cuttings mixture; and
a separator receiving the second drill cutting mixture, the separator configured to separate liquids from solids in the drill cuttings mixture to form the solids stream and the liquids stream.

2. The system of claim 1, wherein the mixer of the second stage is further configured to reduce the size of the drill cuttings.

3. The system of claim 1, wherein the separator of the first stage also generates a liquid stream; and further comprising a first liquid-liquid separator receiving the liquid stream from the separator of the first stage.

4. The system of claim 3, wherein the first liquid-liquid separator generates an oil stream and a liquid-additive stream, and further comprising an liquid-additive line that applies at least a portion of the liquid-additive stream to the drill cuttings that enter the first stage.

5. The system of claim 1, wherein the separator of the second stage also generates a liquid stream; and further comprising a second liquid-liquid separator receiving the liquid stream from the separator of the second stage.

6. The system of claim 5, wherein the second liquid-liquid separator generates a second oil stream and a second liquid-additive stream, and further comprising a second liquid-additive line that applies at least a portion of the second liquid-additive stream to the drill cuttings that enter the first stage.

7. The system of claim 1, wherein the at least one treatment fluid supply includes a first and a second treatment fluid supply, and wherein at least one of the first and the second treatment fluid supply applies a selected additive to the drill cuttings exiting the mixer of the first stage.

8. The system of claim 1, wherein the mixer of the first stage reduces the cuttings to a size less than 1000 micrometers.

9. The system of claim 8, wherein the mixer of the first stage further reduces the cuttings to a size no less than 60 micrometers (d50).

10. The system of claim 1, wherein the mixer of the second stage reduces the cuttings to a size between 1000 micrometers (d50) and 60 micrometers (d50).

11. The system of claim 1, wherein the cleaning fluid includes at least water.

12. The system of claim 11, wherein the cleaning fluid includes at least one selected additive.

13. The system of claim 11, wherein the second stage includes at least one gas supply supplying a gas into the mixer of the second stage, wherein the mixer is configured to generate turbulence in the mixture of the cleaning fluid and the drill cuttings using the gas.

14. The system of claim 13, gas is one of: (i) air, and (ii) nitrogen.

15. The system of claim 13, wherein the gas includes at least one second selected additive.

16. The system of claim 13, further comprising at least one of: (i) a pretreatment stage configured to process the drill cuttings before the drill cuttings enter the first stage, and (ii) a post-treatment stage configured to process at least one of: (i) the solids stream from the second stage, and (ii) the liquids stream from the second stage.

17. The system of claim 12, wherein the first stage includes at least one of: (i) a plurality of mixers, and (ii) a plurality of separators.

18. The system of claim 12, wherein the second stage includes at least one of: (i) a plurality of mixers, and (ii) a plurality of separators.
